(19) United States
(12) Patent Application Publication
(10) Pub. No.: US 2003/0185210 A1
(43) Pub. Date: Oct. 2, 2003

(54) Monitoring quality of service in a packet-based network

(76) Inventor: Tony McCormack, Galway (IE)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/107,877

(22) Filed: Mar. 27, 2002

(51) Int. Cl. H04L 12/56

(52) U.S. Cl. 370/392; 370/474

(57) ABSTRACT

A method arid apparatus for generating probe packets for network measurements, in which a first probe packet is generated by normal routing through a protocol stack, following which a packet processor determines, from the routing information added by the stack, a template for generating a series of packets. Based on parameters supplied to the packet processor, a complete stream of probe packets for measuring network performance to a remote endpoint can be generated without further use of the protocol stack. Also provided is a receive-end apparatus and method which determines, by processing a single received probe packet, the format necessary to loop back further packets received in a stream from the same source, and generates the return headers allowing each packet in the stream to be looped back without further involving the protocol stack.

### FIELD OF THE INVENTION

The present invention relates to methods and apparatus for monitoring quality of service in packet-based networks. The invention has particular application in telephony applications including video and voice calls made between nodes of a network.

### BACKGROUND OF THE INVENTION

Voice and video telephony over packet-based networks is dependent on the quality of service over the network. In conventional networks, a large number of gateways (hundreds or thousands) enable communication between users of telephony equipment connected to the gateways, with the data representing voice or video signals being converted to packets behind the gateways for transmission over the network.

Such communications are only acceptable to the users if the packets reach their destination without unacceptable delays or loss of packets. while other factors are also relevant it is the percentage packet loss and the round trip delay which most impact on perceived signal quality.

For this reason conventional telephony gateways connected to a packet-based network tend to monitor these parameters continually, both before and during calls, as a relatively simple means of measuring the quality of service (QoS). The QoS is often expressed as a Mean Opinion Score (MOS) ranging from 1 to 5. While factors other than packet loss and round trip delay are used in calculating MOS scores, it is these two parameters which are most likely to vary during a call and the MOS can be calculated using nominal values for other parameters (which might relate to e.g. the performance of the telephony equipment).

During a call if the QoS drops below a given value, the call may be re-routed over a different network. Before a call is made, however, it is useful to know the expected QoS in order to decide whether a call should be made over the packet-based network or whether an alternative routing should be used.

In order for this initial decision to be made, gateways on a network will typically make dynamic measurements of the network performance between itself and each other gateway to which a call might be made. A minimum QoS or MOS score level is set for the gateway and when an outbound call is placed to another gateway, the dynamic measurements relating to the network connection to that remote gateway are compared with the minimum level. If the connection has a performance better than the minimum threshold the call is made over the network, and if the performance is worse than the specified minimum the call is rejected by the gateway and instead routed via a different network (such as a PSTN network).

The measurements are typically made by each gateway sending probe packets to each of the other (remote) gateways, and these remote gateways then loop back the received packets to the sender. In this way the sender can calculate the round trip delay and percentage packet loss. Typical dynamic measurement scenarios will involve a gateway probing each other gateway every 15 seconds with a series of 25 packets each having a burst rate of 4 ms. It is not unusual for a network to have e.g. 500 VoIP (voice over internet protocol) gateways, and thus each gateway must generate and send 12500 packets every 15 seconds.

This measurement activity imposes a very high overhead on the central processing unit (CPU) of the gateway which must not only generate these packets (which involves appending a user datagram protocol (UDP) header, an internet protocol (IP) header, and a physical layer (e.g. Ethernet) header), but must also process the same packets on their return prior to making the network performance calculations. In addition an equivalent number of probe packets will be received from the remote gateways on the network. Each of these must be processed to determine the source, and the packet headers for the return journey must be substituted before looping back the packets. In other words, for a 500 gateway network, the CPU of each gateway must generate 12500 outgoing packets, process up to 12500 of these packets on their return, process up to another 12500 probe packets from remote gateways, and regenerate headers for these 12500 packets to be returned, giving a potential workload of 50000 packet operations every 15 seconds.

All of this processing must be done simultaneously with the normal handling of calls, which similarly involves preparing packets for the RTP voice data for each call. The probe packet operations therefore artificially limit the true capacity of the gateway to handle calls, since an appreciable proportion of the processing cycles of the gateway CPU (e.g. 20-30%) must be devoted to the “housekeeping” task of monitoring the network connection to each other gateway in the event of a call being placed to those gateways.

It is therefore an object of the present invention to provide a method and apparatus for measuring quality of service in a packet-based network which imposes lower requirements on the processors involved.

### SUMMARY OF THE INVENTION

The invention provides, in a first aspect, a method of generating probe packets for network measurements between first and second endpoints. The method involves the steps of:

a) providing a packet processor at the first endpoint with a first probe packet which includes routing information for transmission to the second endpoint,

b) providing the packet processor with parameters for generating a series of packets for transmission to the second endpoint,

c) deriving, from the routing information in the first probe packet, a template for use in the generation of further probe packets, and

d) with the packet processor, generating from the template and the parameters a series of probe packets for transmission to the second endpoint.

The method of the invention enables the task of generating probe packets (other than an initial probe packet for each destination) to be delegated from the routing stack to a separate dedicated processor, thereby freeing up significant resources of the CPU in a gateway.

Preferably, step a) involves sending data through a routing stack to generate the first probe packet, so that the routing information is included in one or more headers added to the data and in this way forming the first probe packet.

Further, preferably, step a) is performed by a host processor at the first endpoint which includes the routing stack.

Preferably, step d) involves generating the series of probe packets without accessing a routing stack, so that all of the information required for the series is available in the template and the parameters.

The invention also provides an apparatus for generating probe packets for network measurements between first and second endpoints, the apparatus comprising:

a) a host processor at the first endpoint for generating a first probe packet including routing information for transmission thereof to the second endpoint,

b) a probe packet processor for receiving the first probe packet and generating therefrom a template including the routing information,

c) a template memory area accessible by the packet processor for storing the template, and

d) a series parameter memory area accessible by the packet processor for storing parameters required for automatically generating a series of probe packets,

whereby the packet processor can generate from the template and the parameters a series of probe packets for transmission to the second endpoint.

The invention further provides a computer program product in machine readable form. The program contains instructions which when run on a processor (which can be a processor in a computer or in a piece of dedicated equipment) to generate probe packets for transmission from a first endpoint to a second endpoint by:

a) deriving from a first probe packet a template for use in the generation of further probe packets, and

b) generating from the template one or more further probe packets for transmission to the second endpoint.

In another aspect the invention provides a method of processing probe packets received from a remote source. This method involves the steps of:

a) deriving from a received probe packet information identifying the source of the packet and thereby determining routing information enabling the packet to be returned to the source,

b) generating a template including the routing information for application to further received probe packets, and

c) applying the template to a further received probe packet arriving from the source to enable the further received probe packet to be looped back to the source.

According to this aspect of the invention, the resources of the CPU of a gateway can be further freed up by delegating the return routing of received probe packets to a separate dedicated processor.

Furthermore, since the tasks of generating original probe packets by applying a template and of looping back probe packets received from another source using a template share common characteristics, the same dedicated processor can implement both of these aspects of the invention.

Preferably, step a) comprises analysing the packet to determine a source address and port number and step b) comprises including the source address and port number in the template.

Further, preferably, the template is used to generate a header for the packet which is substituted directly for the header of the further received packet without using a routing stack to add routing information when looping back the further received packet.

This aspect of the invention also provides an apparatus for processing probe packets received from a remote source, comprising:

a first processor for deriving from a received probe packet information identifying the source of the packet and thereby determining routing information enabling the packet to be returned to the source, and

a second processor for applying a template based on the routing information to a further received probe packet arriving from the source to enable the further received probe packet to be looped back to the source.

Similarly a computer program product is provided in machine readable form containing instructions which when executed cause a processor to process probe packets received from a remote source by:

a) generating a template for application to received probe packets based on routing information derived from a first received probe packet from the source, and

b) applying the template to further received probe packets arriving from the source to enable them to be looped back to the source.

The invention further provides an apparatus for use in packet-based network measurements between first and second endpoints comprising:

a) a first processor for:

(i) generating a first probe packet at the first endpoint for transmission to the second endpoint, and

(ii) deriving from a received probe packet generated at a remote source information identifying the source of the packet and thereby determining routing information enabling the packet to be returned to the remote source, and

b) a second processor for:

(i) generating from a source template one or more further probe packets for transmission to the second endpoint, and

(ii) applying a loopback template based on the routing information to a further received probe packet arriving from the remote source to enable the further received probe packet to be looped back to the remote source.

Any of the apparatuses of the invention can be embodied in an internet gateway or a private branch exchange having a connection to a data network such as a local area network or the Internet.

The invention provides, in another aspect, a communications network including first and second endpoints and an apparatus as aforesaid for generating probe packets for network measurements between the endpoints.

### BRIEF DESCRIPTION OF DRAWINGS

The invention will now be illustrated by the following descriptions of embodiments thereof given by way of example only with reference to the accompanying drawings, in which:

FIG. 1 is a block diagram of a data network in which the present invention may be implemented;

FIG. 2 is a block diagram of an apparatus according to the present invention;

FIG. 3 shows the process of generating a stream of probe packets and processing the stream on its return;

FIG. 4 shows the format of an IP packet;

FIG. 5 shows the format of a UDP header;

FIG. 6 shows the format of an IP header; and

FIG. 7 shows the process of looping back a received stream of probe packets to a source.

### DETAILED DESCRIPTION OF PREFERRED EMBODIMENTS

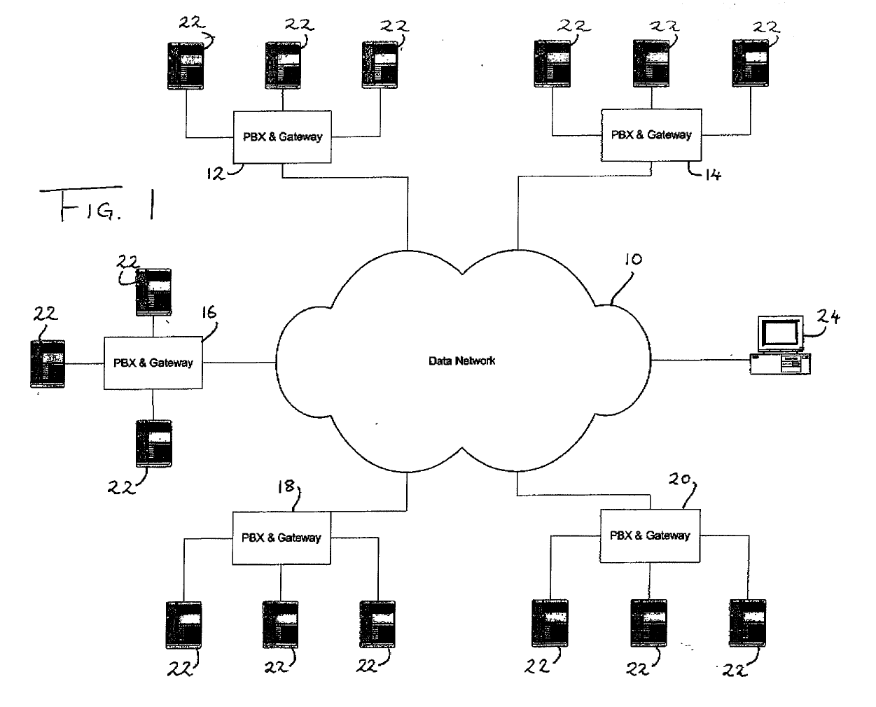

FIG. 1 shows a data network 10 to which a number of private branch exchanges (PBXs) 12,14,16,18 are connected. Bach PBX has an integral Internet protocol gateway (e.g. embodied in a gateway card within the PBX). A number of terminals 22 are connected to the PBXs

The data network 10 can be used to transfer voice over Internet Protocol (VoIP) data between any two handsets, so that calls may be made between terminals (handsets) 22 connected to the network via the gateways. Such systems are well known in the art. Voice, facsimile and other information together with signalling information is switched, from the terminals, in the PBXs to the IP gateway card (not shown) which interfaces with the data network 10. The gateway cards perform conversion of traffic between the format used by the PBX and the format necessary for transport over the data network. The gateway function also handles translation between a dialled number and an internet protocol address. The traffic is typically carried over the data network according to TCP/IP or UDP/IP formats; signalling typically being carried by TCP packets and speech data by a stream of real time transport protocol (RTP) user datagram protocol (UDP) packets. The speech or other voice band information is packaged into data packets which each have a header that carries information to allow the packet to be routed across the data network 10. The data network 10 can be a private IP-based data network or intranet or it can be the public internet.

A personal computer 24 is connected directly to the network and can be used as a telephony terminal when suitable software is running on the computer. Where a user is making a call from the computer 24, the functions of the IP gateway card (assembling voice data into packets) are performed by software at the computer 24 itself Again, such apparatus is well known in the art.

As explained above, each gateway will monitor the QoS available over the network to the other gateways, to determine whether or not a call should be placed over the network to a given terminal at a remote gateway or whether the QoS is so poor that the call should be refused (in which case the PBX may instead direct the call over an analog or other network (not shown) or indicate to the user by a tone or otherwise that the number dialled is not available.

In conventional networks, gateway 12, for example, would send a series of 25 probe packets to gateway 18 every 15 seconds with each packet having a burst rate of 4 ms. Such packets are recognised by gateway 18 and looped back to gateway 12 allowing the percentage packet loss, interpacket delay and round trip delay to be measured. Gateway 12 will similarly send a corresponding series of probe packets to each of gateways 14,16,18 and 20 to evaluate QoS to these remote endpoints. In the same manner each of the other gateways 14,16,18,20 will be carrying out its own network measurements in the background when idle and when calls are in progress, resulting in the potential loss of processing resources for handling voice data and in potential additions to network congestion at busy times. It will be appreciated that the system shown is greatly simplified and that there will generally be far larger numbers of gateways and far larger numbers of handsets attached to each gateway.

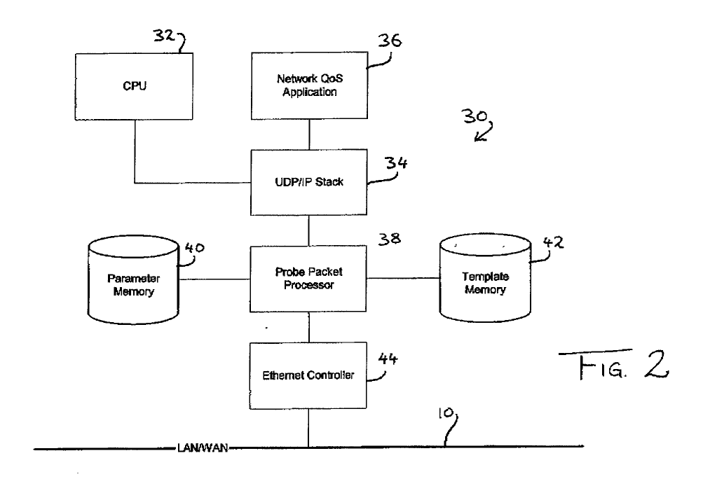

FIG. 2 will now be described to illustrate how such resources are conserved according to the invention. It is a block diagram of the main components of an apparatus 30 according to the invention for generating probe packets. The apparatus 30 comprises a central processing unit (host processor) 32 within the gateway which processes packets within a UDP/IP stack 34. In the case of a gateway embodied in a computer, the CPU is the CPU of the computer. For gateways embodied in PBXs it is a CPU of the PBX or of a gateway module located in the PBX.

A software or firmware QoS monitor application 36 is responsible for monitoring the QoS levels and taking appropriate action (such as refusing calls when QoS drops below acceptable levels, or requesting more network resources). Conventionally this will have been done by generating a series of probe packets each of which is routed to the stack to obtain the Touting information allowing it to be passed over the network to a remote endpoint and allowing the remote endpoint to loop the packet back.

According to the invention, however, the generation of the series of probe packets is delegated to a probe packet processor 38 which uses parameter information stored in a parameter memory area 40 and routing information stored in a template memory area 42 to generate a series of packets without requiring the UDP/IP stack to provide protocol headers for each packet. A system for generating a header template from a given probe packet (though not for generating a series of probe packets) is disclosed in the commonly assigned U.S. patent application Ser. No. 09/349,348 entitled “Processing Data Packets”, filed on Jul. 7, 1999, the contents of which are incorporated herein by reference.

The parameter memory will generally record the required burst rate, number of packets per series, port number etc. for the IP address of a remote gateway. The template memory will store a header template containing routing information for the packets in the series being sent to that address.

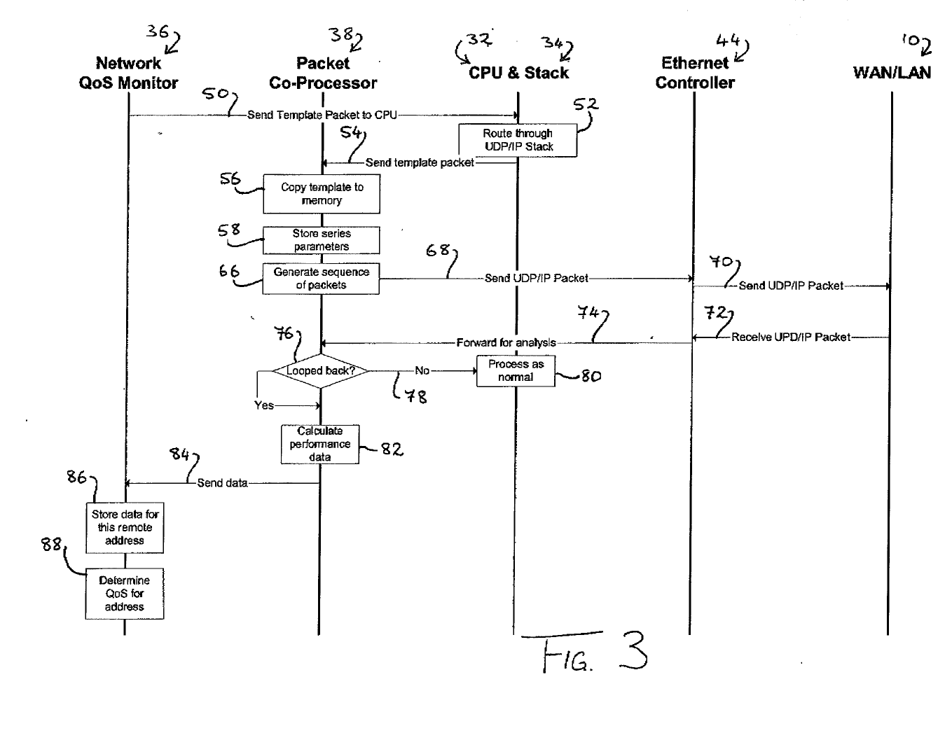

Referring additionally to FIG. 3, the QoS monitor 36 initiates the measurement of network performance to a remote endpoint on the network (e.g. another gateway) by generating a special template packet, step 50, which is routed through the usual UDP/IP routing stack, step 52, and is then received at the probe packet processor, step 54. At this stage the packet will include the UDP and IP headers containing the routing information for a packet to be sent to the remote endpoint and the source and destination port numbers. The payload of the template packet includes a pointer to, i.e. memory address of, a unique template structure stored in template memory 42. This pointer allows the packet to be identified by the packet processor as a template packet. The payload also includes a specification of the parameters characterising the series of packets in the QoS probe stream (i.e. burst rate, delay between bursts and number of packets in the burst).

The packet processor detects the template packet and then copies the header information from the routed packet into the special template structure in the template memory, step 56. The parameters for the series of packets are stored in the parameter memory, step 58. Using these parameters and this header information, the probe packet processor can generate the entire series of probe packets for transmission to the remote endpoint via an Ethernet controller and the data network (WAN/LAN).

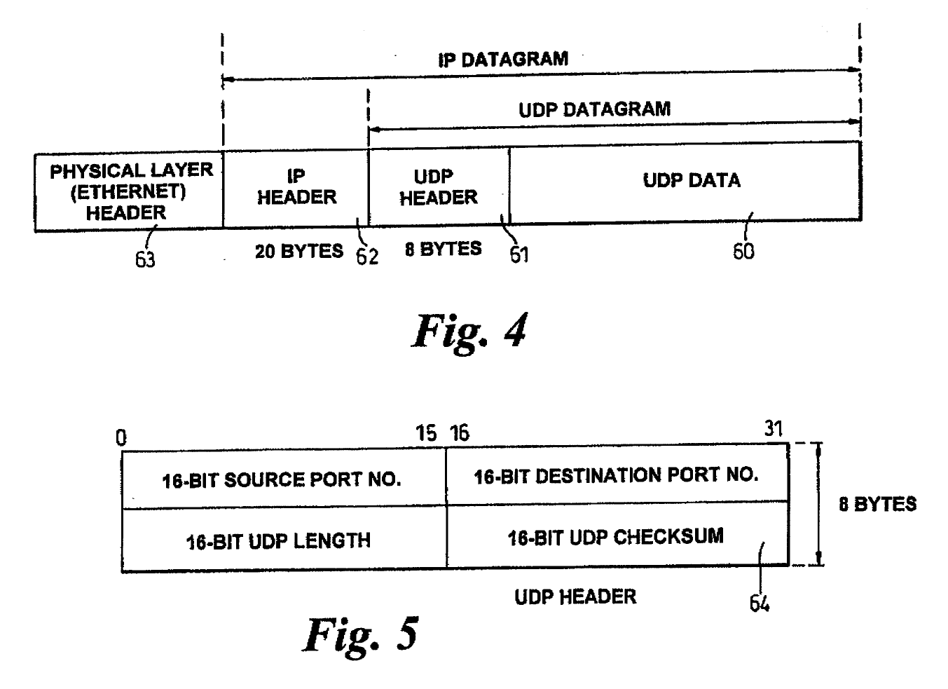

FIG. 4 shows the format of an IP packet or datagram which carries UDP data, and is illustrative of the probe packets generated by the packet processor. The probe packet comprises a payload of UDP data 60, which will consist solely of the series number of the packet within the series (required for the identification of missed packets and the differentiation of packets in a series if interpacket jitter is to be measured), a UDP header (8 bytes) 61, an IP header (20 bytes) 62 and a physical or data link layer header 63. The physical layer is often Ethernet. The length of the payload 60 can vary in general, but for probe packets it is preferred that it should be padded with null bits to a constant length.

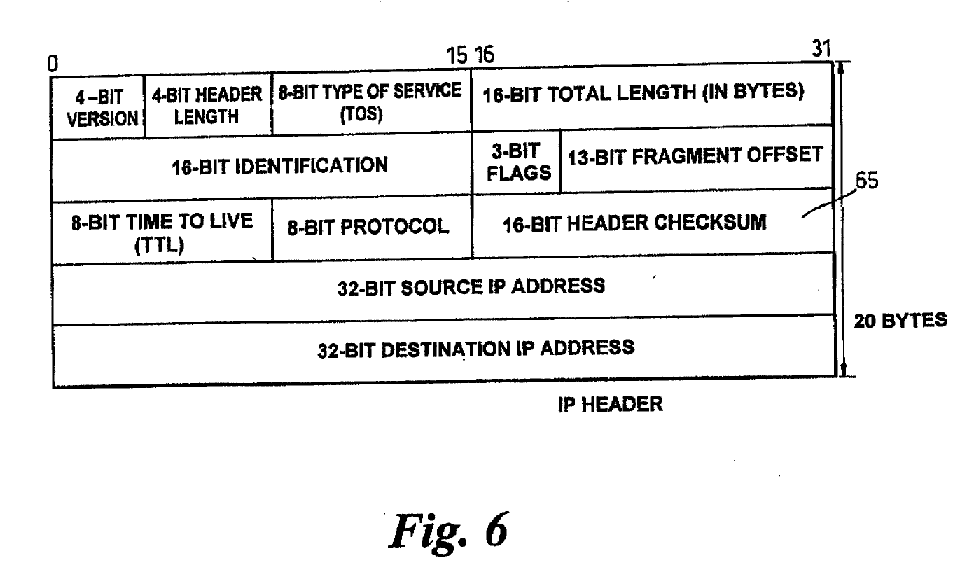

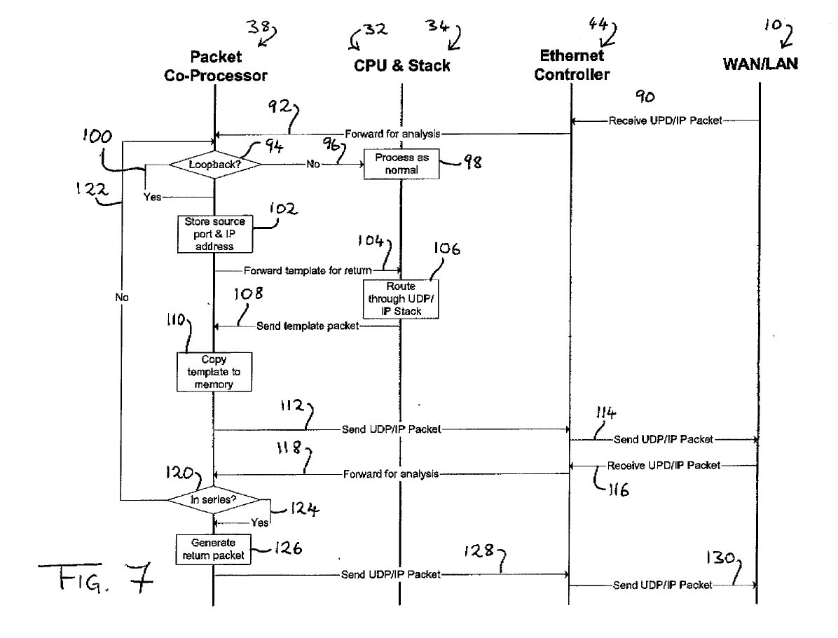

FIG. 5 shows the format of the 8 byte UDP header 61 and FIG. 6 shows the format of the 20 byte IP header 62. The 16-bit UDP checksum 64 of the UDP header is calculated in real time by the packet processor according to data present in the UDP Data 60, UDP header 61 and a portion of the IP header 62.

The IP protocol includes an IP header checksum (65, FIG. 6) which covers the IP header only. The value of the checksum depends, inter alia, on the length of the payload. The IP header is generated by sending a template packet padded to the length which the UDP stream packets will be.

The individual packets in the series are generated sequentially in real time, step 66, by the packet processor in accordance with a scheduler in the packet processor and the stored parameters. As each probe packet is generated it is sent to the Ethernet controller, step 68, for forwarding to the network, step 70. The packet processor then increments the packet identification number in the payload of the next packet until the total number of required packets is generated.

In this way the processing requirements of generating probe packets using the host processor (CPU) and the UDP/IP stack are greatly reduced, with these components being used only in generating the template packet for the series, and for the remainder of the time, these components are free to process the actual data of voice packets involved in calls or to process other tasks. The template can be stored for use in generating a subsequent burst of probe packets to the endpoint in question (e.g. 15 seconds later) or it can be discarded and a new template generated the next time the network connection to that endpoint is to be evaluated. While it is generally desirable to use the template for as long as possible, on some networks routings may change frequently and thus it will be necessary to balance the desire to minimise CPU and IP stack loads with the requirement that the packets are being sent via the correct routings.

In the preferred apparatus of the invention, the packet processor is a lower cost processor than the CPU and is optimized to the job of scheduling packet transmission and applying the template headers to the data stream. This architecture comprises two processors:

a first processor (packet processor 38) which is optimised to handle processing of UDP packets. This processor can be a field programmable gate array (FPGA) or a micro-RISC processor which are often provided as co-processors to Network Processors, such as the IXP1200 from Intel or other device; and

a second processor to handle the gateway functions, including handling the processing of all other packets, i.e. non-RTP packets, and the template packets and running other application code. This second processor can be a CPU such as an Intel 486 or Pentium processor.

A reduced instruction set (RISC) processor or FPGA device has a reduced functionality compared with a full CPU, but has a significantly lower cost compared with the full CPU.

Referring back to FIG. 3, when the probe packets have been looped back from the remote endpoint they are received at the ethernet controller 44 of the source endpoint, step 72; and passed to the packet processor 38 for analysis, step 74. The packet processor examines each packet received to determine, step 76, if this is a looped back packet from a probe stream which originated at this apparatus, and if not, it is passed to the CPU, step 78, for normal processing like any other TCP/IP, UPD/IP or RTP/IP packet, step 80.

If, however, it is determined in step 76 that the packet is a looped-back probe packet, then the packet processor calculates the round-trip delay since this packet was sent, calculates the interpacket delay (relative to other looped-back packets in this stream) and calculates, when a sufficient time has elapsed, the percentage packet loss from this stream, step 82.

These statistics are then sent, step 84, to the QoS monitor which stores the statistics, step 86, and determines what action, if any, needs to be taken in relation to traffic for the address in question, step 88.

FIG. 7 shows a process executed by the same apparatus when it is the receiving endpoint for a stream of probe packets originating from a remote source endpoint (which can be a conventional gateway generating packets through an IP stack or can be a similar apparatus which generates packets using the method of the invention). Upon receipt of a UDP/IP packet, step 90, the Ethernet controller 44 forwards the packet to the packet processor, step 92, to analyses step 94, if this is a probe packet to be looped back to source. If not, the packet may be forwarded to the CPU, step 96, for normal processing, step 98. (Although the processes of FIGS. 3 and 7 are described in isolation from one another for clarity, in practice, a received packet will be subjected sequentially to the analysis of steps 76 (FIG. 3) and 94 (FIG. 7) or vice versa; only if the packet is neither a remotely originating probe packet, or a returning locally originating probe packet, will it be sent to the CPU for normal processing as in steps 78 and 96.)

If the packet processor determines, step 100, that the packet is a probe packet to be looped back to its source, the source IP address is determined from the IP header and the source port number from the UDP header, and these parameters are stored in a loopback parameter area of memory (not shown), step 102. The payload of the packet is then forwarded to the CPU, step 104 where it is processed through the UDP/IP stack, step 106, and the necessary headers for the return trip are added. This packet, which is ready for looping back, is also effectively a template for returning future packets in the series, step 106, which is passed back to the packet processor, step 108 . Then, using this return template packet, the packet processor stores the template, step 110, containing the necessary headers so that future packets received from the same data stream can be processed by stripping away the headers and applying the template headers to the packet (recalculating the checksums where necessary), allowing such packets to be looped back without involving the IP stack further. Once the template is stored, the packet is sent to the Ethernet controller, step 112 for transmission to the network, step 114.

The next time a UDP/IP packet is received, step 116, and forwarded to the packet processor, step 118, a check is first made to see if the packet is a further packet for looping back forming a part of a series for which a template already exists, step 120. If the packet is not in such a series, the process passes, step 122 back to the analysis of step 94 (since a packet may not be part of a series for which a template exists but may be a probe packet for looping back to another source, requiring a further return template to be generated and stored) At any one time the template memory area of the apparatus will usually contain a large number of templates for originating probe packets, and a similar number of templates for probe packets originating at a remote source.

If step 120 determines that the packet is part of a series for which a template exists, step 124, then the headers are replaced by new headers from the relevant return template, step 126, to generate the return packet for transmission in the normal way, steps 128 and 130 The correct template can easily be identified from the multiplicity in the template memory area according to the IP address and port number stored within the templates. The IP address for each template can be used to index the templates.

The invention is not limited to the foregoing examples which can be varied without departing from the spirit and scope of the invention.

What is claimed is:

1. A method of generating probe packets for network measurements between first and second endpoints comprising the steps of:
a) providing a packet processor at the first endpoint with a first probe packet which includes routing information for transmission thereof to the second endpoint,
b) providing said packet processor with parameters for generating a series of packets for transmission to the second endpoint,
c) deriving from the routing information in said first probe packet a template for use in the generation of further probe packets, and
d) with said packet processor, generating from said template and said parameters a series of probe packets for transmission to the second endpoint.

2. A method as claimed in claim 1, wherein step a) comprises sending data through a routing stack to generate said first probe packet, whereby said routing information is included in one or more headers added to the data to thereby form said first probe packet.

3. A method as claimed in claim 2, wherein step a) is performed by a host processor at the first endpoint which includes said routing stack.

4. A method as claimed in claim 2, wherein step d) comprises generating said series of probe packets without accessing a routing stack, whereby all of the information required for the series is available in the template and the parameters.

5. An apparatus for generating probe packets for network measurements between first and second endpoints, said apparatus comprising:
a) a host processor at the first endpoint for generating a first probe packet including routing information for transmission thereof to the second endpoint,
b) a probe packet processor for receiving said first probe packet and generating therefrom a template including said routing information,
c) a template memory area accessible by the packet processor for storing said template, and
d) a series parameter memory area accessible by the packet processor for storing parameters required for automatically generating a series of probe packets,
whereby the packet processor can generate from said template and said parameters a series of probe packets for transmission to said second endpoint.

6. An apparatus as claimed in claim 5, wherein said host processor incorporates a routing stack for generating said first probe packet and wherein said packet processor obtains routing information directly from said template without the use of a routing stack.

7. A computer program product in machine readable form containing instructions which when executed cause a processor to generate probe packets for transmission from a first endpoint to a second endpoint by:
a) deriving from a first probe packet a template for use in the generation of further probe packets, and
b) generating from said template one or more further probe packets for transmission to the second endpoint.

8. A method of processing probe packets received from a remote source, comprising the steps of:
a) deriving from a received probe packet information identifying the source of the packet and thereby determining routing information enabling the packet to be returned to the source,
b) generating a template including said routing information for application to further received probe packets, and
c) applying said template to a further received probe packet arriving from said source to enable the further received probe packet to be looped back to the source.

9. A method as claimed in claim 8, wherein step a) comprises analysing said packet to determine a source address and port number and step b) comprises including said source address and port number in said template.

10. A method as claimed in claim 8 wherein said template is used to generate a header for the packet which is substituted directly for the header of the further received packet without using a routing stack to add routing information when looping back the further received packet.

11. An apparatus for processing probe packets received from a remote source, comprising:
a first processor for deriving from a received probe packet information identifying the source of the packet and thereby determining routing information enabling the packet to be returned to the source, and
a second processor for applying a template based on said routing information to a further received probe packet arriving from said source to enable the further received probe packet to be looped back to the source.

12. A computer program product in machine readable form containing instructions which when executed cause a processor to process probe packets received from a remote source by:
a) generating a template for application to received probe packets based on routing information derived from a first received probe packet from the source, and
b) applying said template to further received probe packets arriving from said source to enable them to be looped back to the source.

13. An apparatus for use in packet-based network measurements between first and second endpoints comprising:
a) a first processor for:
(i) generating a first probe packet at the first endpoint for transmission to the second endpoint, and
(ii) deriving from a received probe packet generated at a remote source information identifying the source of the packet and thereby determining routing information enabling the packet to be returned to the remote source, and
b) a second processor for:
(i) generating from a source template one or more further probe packets for transmission to the second endpoint, and
(ii) applying a loopback template based on said routing information to a further received probe packet arriving from said remote source to enable the further received probe packet to be looped back to the remote source.

14. An apparatus as claimed in claim 5 when embodied in a gateway.

15. An apparatus as claimed in claim 13 when embodied in a gateway.

16. An apparatus as claimed in claim 11 when embodied in a gateway.

17. A communications network including first and second endpoints and an apparatus for generating probe packets for network measurements between said first and second endpoints, said apparatus comprising:
a) a host processor at the first endpoint for generating a first probe packet including routing information for transmission thereof to the second endpoint,
b) a probe packet processor for receiving said first probe packet and generating therefrom a template including said routing information,
c) a template memory area accessible by the packet processor for storing said template, and
d) a series parameter memory area accessible by the packet processor for storing parameters required for automatically generating a series of probe packets,
whereby the packet processor can generate from said template and said parameters a series of probe packets for transmission to said second endpoint.
